(19) United States
(12) Patent Application Publication
(10) Pub. No.: US 2004/0041757 A1
(43) Pub. Date: Mar. 4, 2004

(54) Light emitting diode display module with high heat-dispersion and the substrate thereof

(76) Inventors: Ming-Hsiang Yang, Taipei (TW); Yung-Cheng Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/233,653

(22) Filed: Sep. 4, 2002

(51) Int. Cl. G09G 3/32

(52) U.S. Cl. 345/82

(57) ABSTRACT

A Light Emitting Diode Display Module with high heat-dispersion and the substrate thereof; the Light Emitting Diode Display Module comprises a substrate having high heat-dispersion and a plurality of light emitting diode settled on the substrate; forming an insulating layer on the surface of a metal plate, next to settle the copper circuit layer on the insulating layer, the copper circuit layer could be used on the surface mount light emitting display device, the insulating layer is also a material with fine heat conductivity, especially a metal oxide which conductivity coefficient higher than resin or cellulose, thus the display module will diffuse the produced heat onto the whole circuit board and the heat could be dispersed into the air.

### FIELD OF THE INVENTION

The present invention relates to a Light Emitting Diode Display Module with high heat-dispersion and the substrate thereof, and more particularly to a Light Emitting Diode Display Module using a metal substrate and a stack circuit board of a metal oxide.

### BACKGROUND OF THE INVENTION

Today the Light Emitting Diode full-color display has been broadly used in the advertisement, the outdoor activity and the real-time display of the games that broadcast the images on the large display screen by means of the computer control and to acquire the recognition and support of the on-the-spot crowd. Since most of the LED full-color display are installed in the outdoor or the public architecture space, all the LED used on assembly must have the characteristic of high luminance to provide the view for long distance.

The light-emitting efficiency of the conventional high luminance LED is about 10-15 Luminance/watt (Lm/W), the light-emitting efficiency could be achieved to above 50 Lm/W through continue betterment and elevation. In order to keep on elevating the luminance, except for solving the problem of outside encapsulation, it also requires to design it with the characteristic of accepting higher power as well as larger current performance. Since the increase of the power in consumption will also cause the serious problem produced by the heat energy, the over-heat working temperature will make the luminance of the LED unable to reach the required specified standard that seriously influences the performance of all the LED display.

As shown in FIG. 1, the display module of the conventional LED display adheres a plurality of LED 11 on a printed circuit board 12 with the style of high-density array. Since there is poor heat-conduction performance for the encapsulation body 111 of the LED 11, most of the heat energy produced by chip 110 is conducted out through the outer lead 112. Some heat energy is dissipated to the ambient environments directly through the outer lead 112 (the heat-transfer pathway is shown in arrow); another portion of the heat is conducted to the printed circuit board 12 and being dispersed.

The area and the heat-dispersion capacity of the metal circuit 121 of the printed circuit board 12 is limited, most of the heat produced should be dispersed through the composite substrate 122 occupying the maximum proportion such as FR-4. However, FR-4 is composed by immersion and press of the epoxy resin and the glass fiber with poor heat conduction, thus it could not conduct the heat energy with efficiency. In other words, most of the heat energy transferred by the chip 110 could not be dispersed through the surface of the substrate 122. The same as this, not only the FR-4 substrate has the drawback of poor heat dispersion, the substrate made by other polymer resin and the cellulose shaped reinforced material face the same problem. Besides, the substrate module produced by NIPPON RIKA KOGYOSHO CO., LTD, JAPAN in the market today claims to have a fine effect of heat dispersion. Although the substrate is composed of the metal plate with fine heat conduction performance, its insulation layer is composed of adhering the thin polymer material on the metal substrate which thickness is about 140 μm. It is well known that the heat conductivity of the polymer material is poor which coefficient (which is about 1.6-4.0 W/m·K) is far smaller than the metal or the metal oxide (which is about 50-200 W/m·K.), So the heat energy produced on the circuit of the insulating layer is hard to pass through the insulating layer composed by the polymer material and next to the metal substrate and to the substrate. Besides, it cannot be perforated upon the module for these kinds of module since it could not be insulated inside the hole, which thus could not be applied on the staggered module. To think of this, this invention provides a novel module structure that not only solves the problem of heat dispersion but also applying it on the staggered circuit board.

### BRIEF DESCRIPTION OF THE INVENTION

The primary object of this invention is to provide a Light Emitting Diode display module with high heat dispersion which could transfer the heat produced by the LED onto the surface of the substrate efficiency, next to disperse the heat to the ambient environments through the vast area of its surface.

The second object of this invention is to provide a material which could decrease the cost of heat-dispersion of the display module, which could save the related costs such as the fan fin, the heat conduction pipes or the heat dispatch sheet used by the display module.

The third object of this invention is to provide a reliable way of heat dispersion for the display module, which one would never worry about the trouble, happened on the heat-dispersion device and cause the shutdown of the display module or the whole system.

The fourth object of this invention is to provide a manufacture method of a substrate which forms the insulating layer and the circuit layer on the surface directly by utilizing the metal plate, it has the simpler manufacture steps in comparison with the multi-layer circuit board.

To accomplish the above objectives, the present invention provides a light-emitting diode display module with high heat-dispersion comprising a substrate with high heat-dispersion and a plurality of light emitting diode and electric devices settled on the substrate. The major composite of the substrate is a metal plate, and an insulating layer is formed on the surface of the metal plate which insulating layer is the insulating substrate formed by a metal compound. To set-up the circuit layer above the insulating layer by means of the process of surface activation and electroplating, the circuit layer is used for the surface mounting of the electric device or the optic-electric device and the electric-connection. Since both the metal oxide and the metal plate are the materials with fine heat conduction, it could transfer the heat energy produced by the electric devices or the optic-electric devices settled on the substrate onto the whole substrate with efficiency such that the heat energy could be dispersed into the air through the more vast surface area.

The present invention achieves these benefits in the context of known process technology. However, a further understanding of the nature and advantages of the present invention may be realized by reference to the latter portions of the specification and attached drawings.

### BRIEF DESCRIPTION OF THE DRAWINGS

The features and advantages of Light Emitting Diode Display Module according to the present invention will be more clearly understood from the following description taken in conjunction with the accompanying drawings in which like reference numerals designate similar or corresponding elements, regions, and portions and in which:

FIG. 1 is the heat-dispersion path illustration view of the multi-layer circuit board according to the conventional light emitting diode display module;

FIG. 2 is the structure illustration view of the single-layer substrate of the light emitting diode display module according to the present invention;

FIG. 3 is the structure illustration view of another single-layer substrate of the light emitting diode display module according to the present invention;

FIG. 4 is the structure illustration view of the through-hole typed dual layer substrate of the light emitting diode display module according to the present invention;

FIG. 5 is the structure illustration view of another dual layer substrate of the light emitting diode display module according to the present invention;

FIG. 6 is the heat-dispersion path illustration view of the first embodiment of the light emitting diode display module according to the present invention;

FIG. 7 is the heat-dispersion path illustration view of the second embodiment of the light emitting diode display module according to the present invention;

FIG. 8 is the manufacture flow sheet view of the single-layer substrate of the light emitting diode display module according to the present invention; and

FIG. 9 is the manufacture flow sheet view of the dual-layer substrate of the light emitting diode display module according to the present invention.

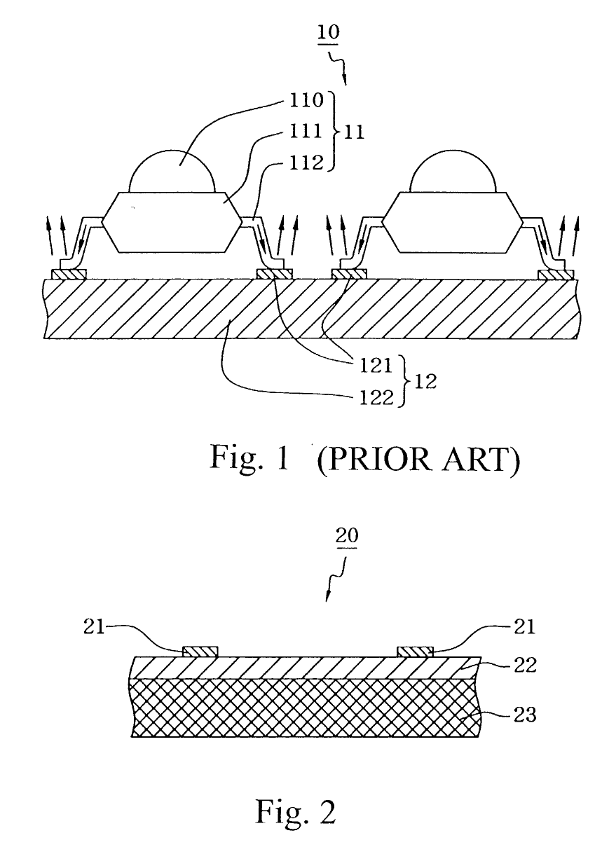

### DETAILED DESCRIPTION OF THE PREFERRED EMBODIMENTS

To give a detailed description, Please refer to FIG. 2, which is the structure illustration view of the single-layer substrate of the light emitting diode display module according to the present invention. Cover an insulating layer 22 above a metal plate 23, the insulating layer 22 is the metal compound of the metal plate, i.e., the oxide film layer or the nitride film layer, it also could be a ceramics material deposited on the surface of the metal plate 23. By utilizing the insulating film 22 it could replace the conventional composite material, i.e., the electrical insulator between the circuit layer 21 and the metal plate 23, and it forms an insulating film layer of aluminum oxide or aluminum nitride. From table 1 it is known that the heat conduction coefficient of aluminum is 237 W/M·K, that of aluminum oxide is 46 W/M·K, and that of aluminum nitride is 140-230 W/M·K. The above-mentioned material has better heat conductivity in comparison with FR-4 which is 0.2 W/M·K, meanwhile, it also proves that the conventional substrate of the Light Emitting Diode display module is almost an insulator of heat. On the other hand, whatever the aluminum oxide or the aluminum nitride is also a good electrical insulator that could prevent the electrons of the circuit layer 21 passing through the metal plate 23 to cause short. In general, the driving voltage of the red light LED is 1.8 V whereas others like the green light or the blue light is 3.5V, so the substrate of this invention used in LED display has relatively reliable safety of electricity.

TABLE 1

| | Heat conductivity | Resistor value |
|---|---|---|
| Material | coefficient (W/M · K) | Ω · cm |
| Aluminum | 237 | 2.8 * 10\hat{ }(⁻⁶) |
| Copper | 401 | 1.7 * 10\hat{ }(⁻⁶) |
| Iron | 80.2 | 75-100 * 10\hat{ }(⁻⁶) |
| Aluminum oxide | 46 | >10\hat{ }(¹⁴) |
| Aluminum nitride | 140-230 | >10\hat{ }(¹⁴) |
| FR-4 | 0.2 | >10\hat{ }(¹⁴) |

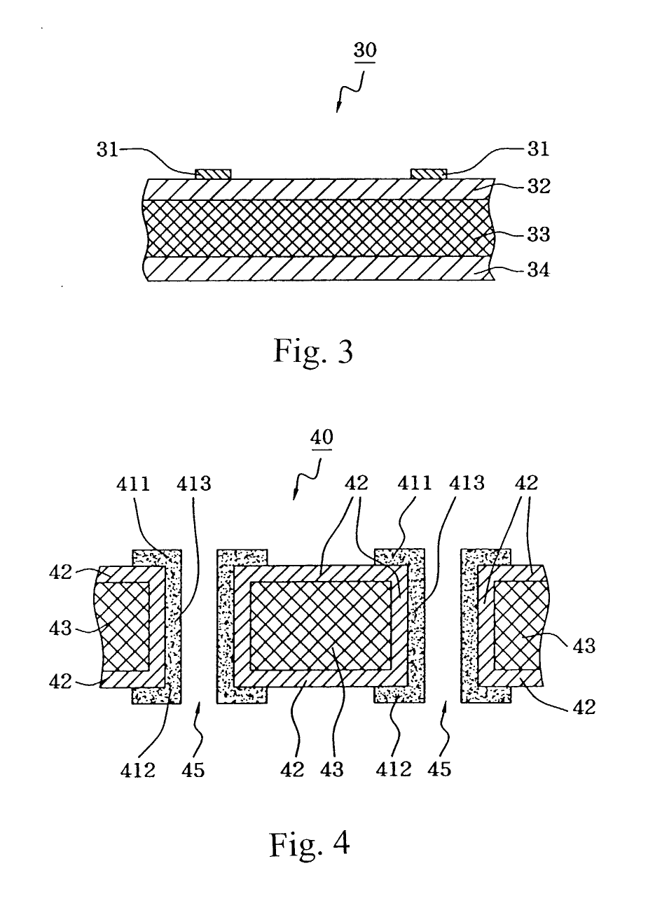

To avoid the exposure of the metal plate 33, which is easily to make it get in touch with other circuits in the systems and cause short, it is required to form another insulating layer 34 on the bottom of the metal plate 33. As shown in FIG. 3, the same substrate 30 has an insulating layer 32 and a circuit layer 31 staggering placing on the top surface of the metal plate 33. Except for considering the substrate suitable for the surface mount devices, this invention also provides the substrate in usage by the plug typed device as shown in FIG. 4. The inner wall of the through hole 45 has the vertical conducting wires 413 to make it electrical-connection between the upper circuit layer 411 and the lower circuit layer 412. Inside the substrate 40 a metal plate 43 comprising a plurality of holes, whereas there forms the protective insulating layer 42 on the holes of the metal plate 43 and on the upper and lower surface of the metal plate 43.

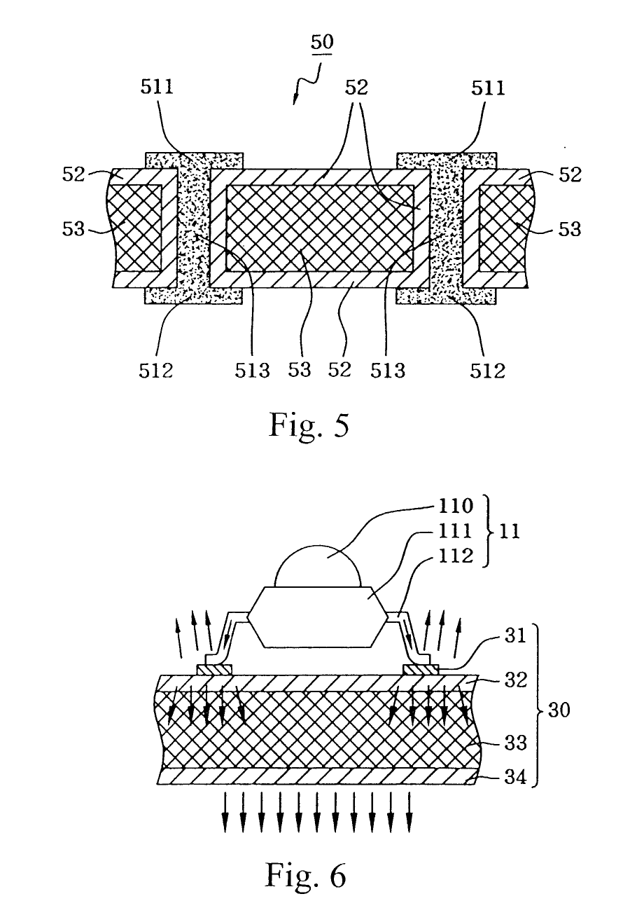

As shown in FIG. 5, which is the substrate applicable to another surface mount device (SMD), it also drill on the metal plate, and it also forms the protective insulating layer 52 on the peripheral of the through hole and on the surface of the upper and lower plates. Inside the through hole there is a vertical wire 513 which is used to electric-connection between the upper circuit layer 511 and the lower circuit layer 512, it could settle the circuit pattern on both facets of the forms of substrate or welding the SMD on it.

FIG. 6 shows the heat-dispersion path illustration view of the first embodiment of the light emitting diode display module according to the present invention wherein the heat-dispersion path is represented as an arrow. The heat energy produced by the internal of the encapsulation body 111 of the LED 11 is conducted onto the substrate 30 through the outer lead 112, a small portion of heat energy is scattered from the upper surface of the outer lead 112, most of which is conducted from the upper insulating layer 32 to the lower insulating layer 34 and disseminates to the air, whereas the metal plate within transfers the heat energy of the upper insulating layer 32 onto the upper insulating layer.

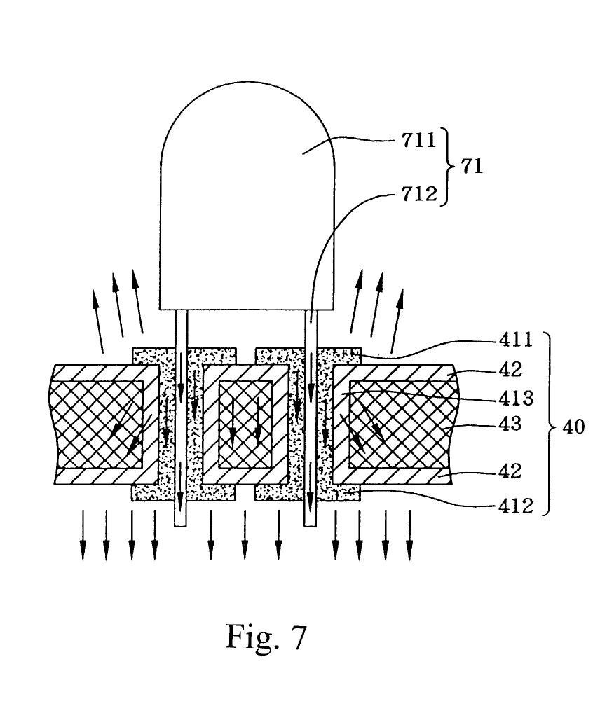

Another heat-dispersion path of the substrate 40, which is applicable for the stitch typed LED 71, is roughly the same, as shown in FIG. 7. Most of the heat energy produced by the interior of the encapsulation body 711 is also conducted onto the upper surface and the lower surface of the whole substrate 40, which expands the heat-dispersion area to the maximum limit.

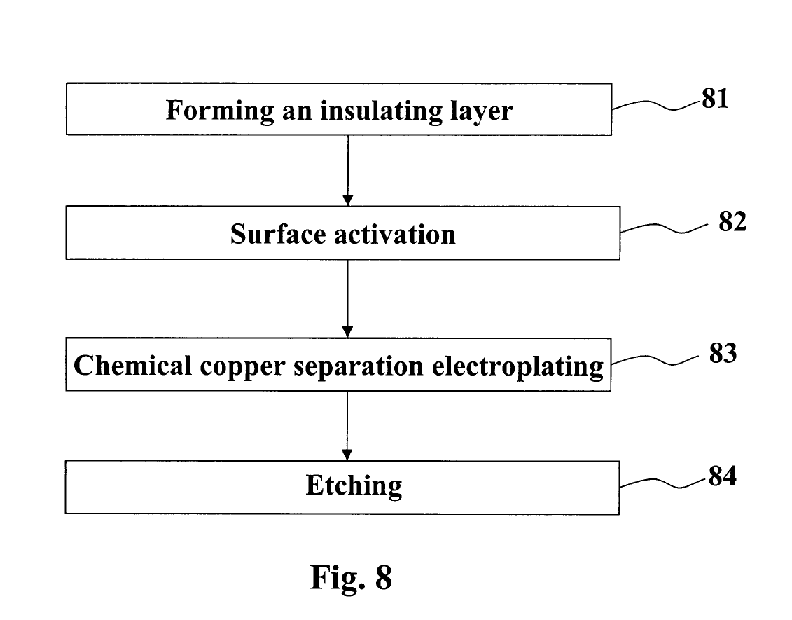

Utilizing to better the conventional manufacture method of the printed circuit board as well as combing the advantage of the semiconductor process could accomplish the above-mentioned manufacture method of the substrate. FIG. 8 is the manufacture flow sheet view of the single-layer substrate of the light emitting diode display module according to the present invention. First select a metal plate with fine heat conductivity such as aluminum, copper or ferrite plate, next form the even insulating layer on its surface according to step 81. Many methods are suitable for forming the insulating layer comprising the heat oxidation method, the gas phase deposition method or the anode treatment, etc. Since it is not easy for adhering other substrates on the insulating layer, it must first completes the steps of surface activation 82 and next proceed the step of chemical cooper separate electroplating 83, thus a cooper electroplating layer is covered with uniform on the surface of the insulating layer. Next take the step of etching 84 to form a pattern of circuits on the cooper-electroplating layer and to corrode the portion outside the circuits.

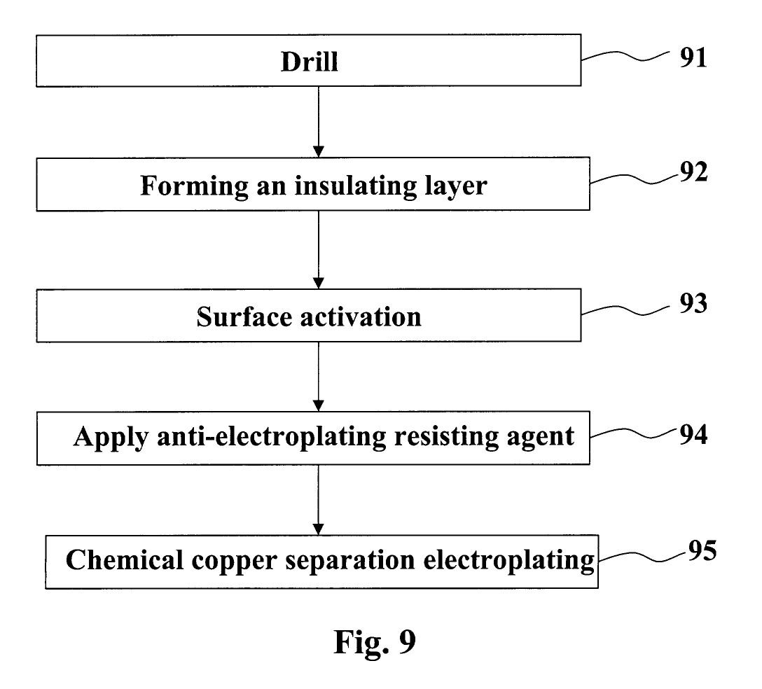

FIG. 9 is another manufacture flow sheet view of the dual-layer substrate of the light emitting diode display module according to the present invention. The difference with FIG. 8 is that it must drill on the metal plate before the step 92 of forming the insulating layer, for example step 91, the same, it must proceed the step 93 of surface activation after the step 92 of forming the insulating layer. Besides, another difference with FIG. 8 is at step 94, apply anti-electroplating resisting agent on the surface of the insulating layer, spread and cover the material of anti-electroplating toward the portion without circuits, so when proceeding the subsequent step 95 of chemical copper separate electroplating, the pattern of copper adheres directly on the portion without anti-electroplating resisting agent.

While the invention has been particularly shown and described with reference to the preferred embodiments thereof, it will be understood by those skilled in the art that various changes in form and details may be made without departing from the spirit and scope of the invention.

What is claimed is:

1. A Light Emitting Diode Display Module with high heat-dispersion comprising a substrate having high heat-dispersion and a plurality of light emitting diode settled on said substrate, which is characteristic in that said substrate comprises:
a metal plate;
an insulating layer, which is to be coating an insulating material on the surface of said metal plate; and
at least a circuit layer over the surface of said insulating layer.

2. The Light Emitting Diode Display Module of claim 1, wherein said insulating layer is the metal compound of said metal plate.

3. The Light Emitting Diode Display Module of claim 1, wherein said insulating layer is the metal oxide of said metal plate.

4. The Light Emitting Diode Display Module of claim 1, wherein said insulating layer is the metal nitride of said metal plate.

5. The Light Emitting Diode Display Module of claim 1, wherein said substrate is the ceramics material.

6. The Light Emitting Diode Display Module of claim 1, wherein said substrate is at least formed on one surface of said metal plate.

7. The Light Emitting Diode Display Module of claim 1, wherein chemical copper separation electroplating forms said substrate.

8. The Light Emitting Diode Display Module of claim 1, wherein said substrate is produced by thermal oxidation method, gas phase deposition method or anode treatment.

9. The Light Emitting Diode Display Module of claim 1, wherein said plurality of light emitting diode is the surface mount typed device.

10. The Light Emitting Diode Display Module of claim 1, wherein said substrate further comprises a plurality of through hole, the interior wall of said through hole is covered by said insulating layer, and a plurality of vertical conducting wires is settled on the surface of the insulating layer of said through hole.

11. The Light Emitting Diode Display Module of claim 10, wherein said a plurality of through hole could be inserted inside by the stitch of a plurality of insert-hole typed Light Emitting Diode and electric-connecting to said circuit layer through said plurality of vertical conducting wire.

12. A high heat-dispersion substrate, comprising:
a metal plate;
an insulating layer, which is to be coating an insulating material on the surface of said metal plate; and
at least a circuit layer over the surface of said insulating layer.

13. The substrate of claim 12, wherein said insulating layer is the ceramics material.

14. The substrate of claim 12, wherein said insulating layer is the metal compound of said metal plate.

15. The substrate of claim 12, wherein said insulating layer is the metal oxide of said metal plate.

16. The substrate of claim 12, wherein said insulating layer is the metal nitride of said metal plate.

17. The substrate of claim 12, wherein said insulating layer is produced by thermal oxidation method, gas phase deposition method or anode treatment.

18. The substrate of claim 12, wherein said metal plate further comprises a plurality of through hole, the interior wall of said through hole is covered by said insulating layer, and a plurality of vertical conducting wires which is settled on the surface of the insulating layer of said through hole.
